(19) United States
(12) Patent Application Publication
(10) Pub. No.: US 2004/0117454 A1
(43) Pub. Date: Jun. 17, 2004

(54) Collaboration cube for a portable computer device

(76) Inventors: Eren S. Koont, Silver Spring, MD (US); Robert A. Lorentzen, Carrollton, TX (US); David M. Newman, Sachse, TX (US)

Correspondence Address: TEXAS INSTRUMENTS INCORPORATED, P O BOX 655474, M/S 3999, DALLAS, TX, 75265

(21) Appl. No.: 10/318,987

(22) Filed: Dec. 13, 2002

(51) Int. Cl. G06F 15/167

(52) U.S. Cl. 709/213

(57) ABSTRACT

A simple, non-network solution for portable computing devices such as calculators and PDAs that allows students to collaborate on a project stored as data on a “collaboration cube.” The collaboration cube is a stand-alone device with input ports to connect several portable computing devices with a wired interface connection. Software on each user's device would read and write to commonly accessible memory on the collaboration cube to share project data between the users.

### TECHNICAL FIELD OF THE INVENTION

This invention relates to portable electronic computing devices such as personal learning tools (PLTs), calculators and personal digital assistants (PDAs), and more particularly to a simple system for connecting multiple portable computer devices to allow the users to collaborate on a project stored as data on the system.

### BACKGROUND OF THE INVENTION

The PLT is a new type of learning device that is being applied to the learning environment. It is a portable computer device that can assist students in learning multiple subjects such as math, science and social studies. Portable computer devices such as PLTs, calculators and PDAs in the past have been focused primarily on individual use. In some cases, such as the classroom environment, the students are typically limited to working on their own individual projects. Some of these devices have wired or wireless links to connect two devices or to make a connection to a personal computer (PC). Also, classroom networks can be implemented to provide some level of interaction, but networks are costly and sophisticated.

### SUMMARY OF THE INVENTION

The present invention provides portable computing devices such as PLTs, calculators and PDAs a simple, non-network solution to allow the users to collaborate on a project stored as data on a “collaboration cube.” The collaboration cube is a stand-alone device with input ports to connect several portable computing devices with a wired interface connection. Software on each user's device would read and write to commonly accessible memory on the collaboration cube to share project data between the users.

In an embodiment of the present invention, the collaboration cube is a stand-alone system that two or more students can connect to their calculator. The cube has a common memory space made accessible to the connected calculators. The calculators communicate to the memory over a serial data bus such as a USB.

An advantage of the present invention is a simple peer-to-peer network like connection for collaboration for hand-held computer devices without the complexity of a network.

Another advantage of the present invention is the simplicity of the solution compared to network solutions also reduces the cost and maintenance of the system.

### BRIEF DESCRIPTION OF THE DRAWINGS

FIG. 1 illustrates a system block diagram according to an embodiment of the present invention.

FIG. 2 illustrates a block diagram of the collaboration cube according to an embodiment of the present invention.

FIG. 3 illustrates a block diagram of a portable computer according to the prior art and used with an embodiment of the present invention.

### DETAILED DESCRIPTION OF THE INVENTION

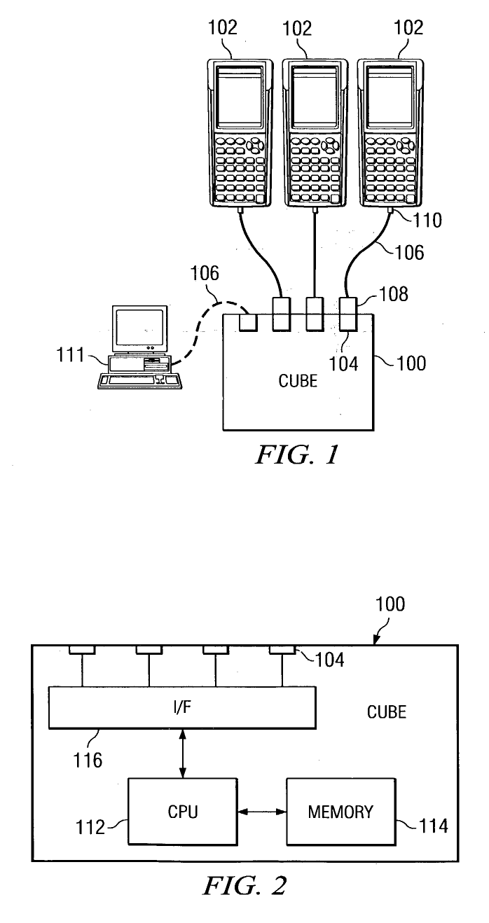

A system level embodiment of the present invention is illustrated by the block diagram shown in FIG. 1. A collaboration cube 100 is connected to several portable or hand-held computer devices 102. The cube collaboration cube 100 has multiple interface ports 104 to make the connection to the portable computer devices 102. In the illustrated embodiment the cube has 4 interface ports, but a larger or smaller number may also be desirable. The portable computer devices 102 are connected to the interface port with a cable 106, which has a connector 108 to connect to an interface port, an a connector 110 to connect to the portable computer device. The interface cable 106 in a preferred embodiment is a 3 wire cable for a serial interface described below.

The collaboration cube 100 can also be connected through an interface port 104 to a computer 111 with a similar cable 106. The connection to the computer is preferably not required to be maintained during the use of the cube. For example, the teacher may use the connection with the computer to load the cube with data prior to class.

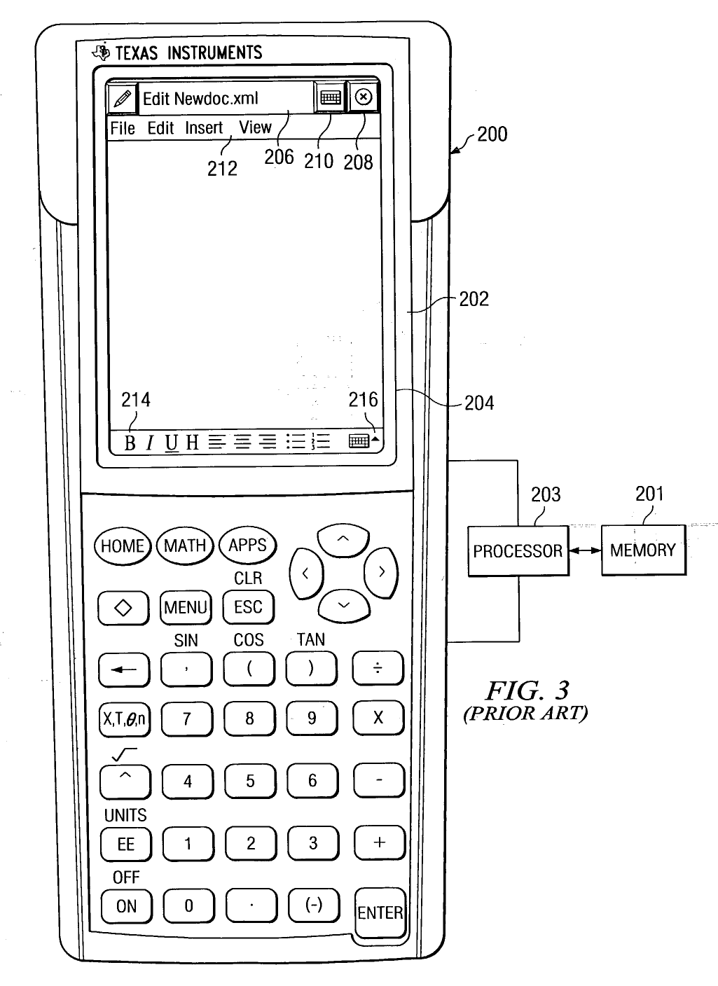

FIG. 2 shows a block diagram of a collaboration cube 100 according to an embodiment of the present invention. The collaboration cube 100 has a CPU 112 connected to a memory block 114 and an interface 116. The memory in a preferred embodiment is a flash ROM. The memory block could also be RAM based memory. The CPU controls access to the memory from the different portable computers 102 connected to the interface as described above. The interface 116 provides connection between the CPU and memory to the portable computers through the interface cables 106 connected to the interface ports 104. In a preferred embodiment, the interface 116 provides standard USB ports to the portable computers.

In a preferred embodiment, the collaboration cube as shown in FIG. 2 has a relatively simple CPU function. The cube acts as a simple server to allow access to files stored in memory from the interface ports. The CPU controls the users access to post and read files on the memory. In most cases, a single user is allowed to have access to a file at any given time.

In the simple CPU function embodiment, the cube can be used in the classroom in a variety of ways. For example, the teacher could use the single user access feature to create a race game where the students race to access files and add answers to problems or questions. Also, the teacher could load a multi-media document to the cube and allow the students to produce a collaborative work to turn in as a group. In another scenario, the teacher could ask the students to jointly compose a document where each student provides a portion of the document.

In another preferred embodiment, the collaboration cube as shown in FIG. 2 has a more complex CPU function. In this smart cube embodiment, the cube takes an active roll in the management of the collaboration process. In this embodiment, the computer connected to the cube or other portable devices can be used to download software into the memory in addition to data files. The cube can initially be connected to the computer for downloading data and software for a collaborative activity. The cube can then be used stand-alone with the hand held computing devices where the cube controls the collaborative activity.

An example for using the smart cube in the classroom is a composition activity, which could be as follows. The teacher could connect the computer to the cube and load activity software and data for the activity. The data for the activity could include a list of topic sentences and the outline of a paragraph. The software could include instructions to randomly send each student a topic. The students could submit their completed topic sentence to the cube to be shared with the other students. The cube could then respond to the student, sending additional instructions to further the activity based on the student's response. In this way, the cube is controlling the collaboration via the downloaded software in its memory.

FIG. 3 illustrates a computer or hand held computing device 200 that is used in conjunction with the collaboration cube of the present invention. The device executes software described herein stored in memory 201 on the processor 203. The device has a display screen 202 having a display area 204. In this embodiment, the display is a touch sensitive display that uses a stylus for input (not shown).

The display includes a header bar 206 that shows the current tool (in this case a compound document editor tool called “Edit”). The file name of the current open document on the display is also shown on the header bar (“newdoc”). In addition, the header bar shows an icon for closing the tool 208 and a keyboard icon 210 to bring up a “QWERTY” keyboard on the display for input of characters with the stylus. The display area 204 further includes a top button bar 212 that has drop down menus for file, edit, insert and view functions. The display area 204 also has a bottom button bar 214 that has text formatting options, a keyboard button, and an icon 216 to pop-up another menu for inserting text symbols.

### Other Embodiments

Although the present invention has been described in detail, it should be understood that various changes, substitutions, and alterations could be made hereto without departing from the spirit and scope of the invention as defined by the appended claims.

The features that are the subject of the present invention could be incorporated into other into other computer based teaching tools and computers. Similarly, other embodiments include the same user interface functionality in a ROM software application package that is executed on a computer, graphing calculator or other handheld device.

What is claimed is:

1. A system for allowing local collaboration of user data between portable computer devices comprising:
a. at least two multi-purpose portable computer devices;
b. a plurality of input ports for the at least two portable computer device;
c. a logic circuit for control of data over the data ports;
d. a memory block for storing collaboration user data received from the input ports;
e. wherein the data is accessible from the input ports of the portable computer devices when the portable devices are plugged into the input ports.

2. The system of claim 1, further comprising an input port for a computer device.

3. The system of claim 1, wherein the logic circuit is a CPU and the memory block is also for storing software instructions that are executable by the CPU.

4. The system of claim 3, further comprising an input port for a computer device.

5. The system of claim 1, wherein the collaborative user data is a text based document viewable on the portable computers.

6. The system of claim 1, wherein the user data includes a data file including one of the following: images, sound, and graphical objects.

7. The system of claim 5, wherein the portable computer devices are calculators.

8. The system of claim 5, wherein the portable computer devices are PDAs.

9. The system of claim 1, wherein the portable computer devices are calculators.

10. The system of claim 1, wherein the portable computer devices are PDAs.

11. A collaboration cube for allowing local collaboration of student user data between portable computer devices comprising:
a. a plurality of input ports for the at least two portable computer device to receive student user data for collaboration;
b. a logic circuit for control of data over the data ports;
c. a memory block for the storing student user data;
d. wherein the data is accessible from the input ports of the portable computer devices when the portable devices are plugged into the input ports.

12. The system of claim 11, further comprising an input port for a computer device.

13. The system of claim 11, wherein the logic circuit is a CPU and the memory block is also for storing software instructions that are executable by the CPU.

14. The system of claim 13, further comprising an input port for a computer device.

15. The system of claim 11, wherein the student user data is a text based document viewable on the portable computers.

16. The system of claim 11, wherein the portable computer devices are calculators.

17. The system of claim 11, wherein the portable computer devices are PDAs.
